(19) United States
(12) Patent Application Publication
(10) Pub. No.: US 2026/0228607 A1
(43) Pub. Date: Aug. 6, 2026

(54) FACT-BASED KNOWLEDGE-DOMAIN-SPECIFIC QUALITY REVIEW OF AI-GENERATED CONTENT

(71) Applicant: Microsoft Technology Licensing, LLC, Redmond, WA (US)

(72) Inventors: Mehmet Mertz ÖZ, Baden (AT); Simeon KREDATUS, Wien (AT); Rachel WITIES, Givat Shmuel (IL); Aaron Toby BORNSTEIN, Zikhron Yaakov (IL); Raimund FISCHER, Vienna (AT); Ksenya KVELER, Nesher (IL)

(21) Appl. No.: 19/044,350

(22) Filed: Feb. 3, 2025

(51) Int. Cl. G06N 20/00; G06F 11/34

(52) U.S. Cl. CPC G06N 20/00; G06F 11/3414

(57) ABSTRACT

A system may extract first input entities corresponding to a knowledge domain from input data and first output entities corresponding to the knowledge domain from output data, wherein a set of first entities includes one or more of the first input entities or the first output entities. The system may map at least some of the first input entities to at least some of the first output entities. The system may output the set of first entities indicating a mapping status for each of the set of first entities.

### BACKGROUND

As generative artificial intelligence (AI) technologies continue to improve and gain popularity, AI language models are increasingly relied upon for content generation tasks, such as question answering. However, it is challenging to evaluate the quality of outputs of AI language models, which may include hallucinations, omissions, and/or harmful information (e.g., confidential information, information generating safety issues).

### SUMMARY

In some aspects, the techniques described herein relate to a method of processing output data generated by an artificial intelligence model from input data, wherein the output data and the input data are associated with a knowledge domain, the method including: extracting first input entities corresponding to the knowledge domain from the input data and first output entities corresponding to the knowledge domain from the output data, wherein a set of first entities includes one or more of the first input entities or the first output entities; mapping at least some of the first input entities to at least some of the first output entities and outputting the set of first entities indicating a mapping status for each of the set of first entities.

In some aspects, the techniques described herein relate to a system for processing output data generated by an artificial intelligence model from input data, wherein the output data and the input data are associated with a knowledge domain, the system including: one or more hardware processors; a memory; an entity extractor storable in the memory, executable by the one or more hardware processors, and configured to perform operations including: extracting first input entities corresponding to the knowledge domain from the input data and first output entities corresponding to the knowledge domain from the output data, wherein a set of first entities includes one or more of the first input entities or the first output entities; mapping at least some of the first input entities to at least some of the first output entities a corrective feedback solicitor storable in the memory, executable by the one or more hardware processors, and configured to perform operations including outputting the set of first entities indicating a mapping status for each of the set of first entities.

In some aspects, the techniques described herein relate to one or more tangible processor-readable storage media embodied with instructions for executing on one or more processors and circuits of a computing device a process for processing output data generated by an artificial intelligence model from input data, wherein the output data and the input data are associated with a knowledge domain, the process including: extracting first input entities corresponding to the knowledge domain from the input data and first output entities corresponding to the knowledge domain from the output data, wherein a set of first entities includes one or more of the first input entities or the first output entities; mapping at least some of the first input entities to at least some of the first output entities; and outputting the set of first entities indicating a mapping status for each of the set of first entities.

Other implementations are also described and recited herein.

### BRIEF DESCRIPTIONS OF THE DRAWINGS

FIG. 1 illustrates an example computing environment for generating, using an entity extractor, a linked entity list from a summary generated by a summary generator from a transcript, and regenerating the summary by inputting corrective inputs to the summary generator generated by an inputs generator based on corrective feedback received at the linked entity list.

FIG. 2 illustrates an example computing environment for presenting, via a corrective feedback interface, a linked entity list, and receiving corrective feedback to the linked entity list via the corrective feedback interface to provide to an inputs generator.

FIG. 3 illustrates an example corrective feedback interface for receiving corrective feedback to a linked entity list.

FIG. 4 illustrates an example of corrective feedback interface for receiving corrective feedback to a linked entity list.

FIG. 5 illustrates an example of corrective feedback interface for receiving corrective feedback to a linked entity list.

FIG. 6 illustrates an example of corrective feedback interface for receiving corrective feedback to a linked entity list.

FIG. 7 illustrates an example corrective feedback interface for receiving corrective feedback to a linked entity list.

FIG. 8 depicts example operations for processing output data generated by an artificial intelligence model from input data.

FIG. 9 illustrates an example computing device for use in implementing the described technology.

### DETAILED DESCRIPTIONS

AI language models may provide outputs that include hallucinations, include omissions, and/or present safety issues (e.g., confidential information, information that generates safety issues). Human-in-the-loop techniques may attempt to solve these problems by including an expert reviewer to review and edit the language model output before it is finalized (e.g., published to clients/users). However, when reviewing lengthy input and output texts in specialized knowledge domains (e.g., legal, medical, etc.), it is difficult for a reviewer to spot all occurrences of hallucinations, omissions, and/or safety issues in the output. Further, even one mistake (e.g., an overlooked omission) may result in anywhere between systems not working as designed to catastrophic mistakes resulting in severe harm to users of the finalized language model output. Accordingly, techniques for finalizing AI-generated outputs (e.g., summaries of call transcripts) require significant and careful review.

The technology disclosed herein addresses the inadequacies of review and editing of AI language model output by linking detected entities in an input text (e.g., the call transcript) and in AI-generated output (e.g., a summary of a call transcript) generated from the input text to provide a reviewer with the correspondence between the detected entities to enable the reviewer to determine the quality of the output text. For example, the correspondence may show corresponding entities (e.g., present in both input text and output text), omitted entities (entity only present in input text), and hallucinations (e.g., entity only present in output text). The technology described herein, in some implementations, may determine the correspondence between entities in the input text and the output text using an ontology that is specific to a knowledge domain of the input text and the output text. Entities of the ontology may be detected within AI language model output and ground truth references by using a named entity recognition (NER) algorithm. Entities (e.g., a topic, a diagnosis, a condition, a symptom) are concepts listed within an ontology. For example, the ontology organizes entities (e.g., concepts) and properties of the entities (e.g., attributes, hierarchical relationships) in a structured way. For example, an ontology may use a graph structure where nodes represent entities and edges represent properties, such as hierarchical relationships.

Accordingly, certain implementations of the disclosed technology provide an ontology-based entity mapping of AI language model output and input texts, which provides for a superior reviewer-assisted evaluation of AI language model output texts over approaches in which a user merely reviews the output text in light of the input text with no entity mapping. The entity list of the disclosed technology enables the reviewer to review at the entity level, providing a superior reviewer-assisted evaluation of AI language model output texts over approaches in which a user must review the output text as a whole.

The disclosed technology may display the entity list that includes entities detected in the input text and the output text along with a corresponding correspondence designation (e.g., correspondence, hallucination, omission). Further, upon selecting an entity in the entity list, the disclosed technology may highlight the entity and its context in one or more of the input text and the output text (e.g., a sentence including the entity). The disclosed technology's designation of the entities of the entities list (e.g., omission, hallucination, correspondence designations) and the highlighting of the location and context (in the input text and/or in the output text) of the selected entity provides information for the reviewer that facilitates the speed and intuitiveness of review that is not present in approaches in which a user must merely review the output text.

The disclosed technology may provide a corrective feedback interface to enable users to edit the entity list to generate a verified entity list. For example, the user may provide corrective feedback to the entity list by confirming, rejecting, or editing one or more of the corresponding entities (e.g., entities included in both input and output text), the hallucination entities (e.g., entities in output text only), and or omission entities (e.g., entities in input text only). The described technology may generate a verified entity list based on the user's feedback to the entity list. The corrective feedback interface of the disclosed technology, which generates a verified ontology-specific entity list based on received corrective feedback, provides a superior review of AI language model output texts over approaches in which a user merely reviews the content of the output text.

The disclosed technology may facilitate the regeneration of the language model output text using the user feedback to the entity list. For example, the disclosed technology may generate inputs (e.g., a prompt) for regenerating the output text that incorporates the user feedback to the entity list (e.g., the user rejects a first hallucination, accepts a second hallucination, and rejects an omission). For example, the inputs may be added to a context window of the language model that includes the original input text, the output text, and the inputs. Accordingly, the entity list of the disclosed technology may enable the generation of superior inputs for language model output text regeneration compared to a reviewer generating inputs unassisted.

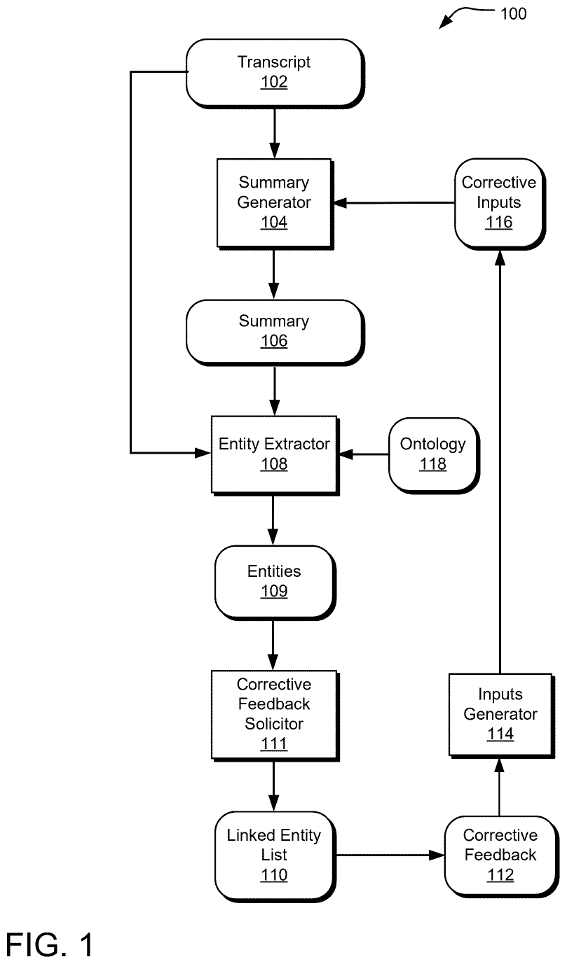

FIG. 1 illustrates an example computing environment 100 for generating, using an entity extractor 108, a linked entity list 110 from a summary 106 generated by a summary generator 104 from a transcript 102, and regenerating the summary 106 by inputting corrective inputs 116 to the summary generator 104 generated by an inputs generator 114 based on corrective feedback 112 received at the linked entity list 110. The example computing environment 100 includes a summary generator 104, an entity extractor 108, and an inputs generator 114.

The summary generator 104, in some implementations, is trained to process and respond to inputs and provide output content specific to a knowledge domain that is responsive to the inputs. For example, the knowledge domain is medical diagnoses, law, rules of a specific organization, or other knowledge domain. The summary generator 104 may be a language model. Examples of language models include large language models (LLMs), transformer-based models (e.g., a generative pre-trained transformer (GPT) model, an Open Pretrained Transformer (OPT) model, or Bioscience Large Open-science Open-access Multilingual (BLOOM) model), as well as seq2seq models, long short-term memory networks (LSTM), and recurrent neural networks (RNNs).

The inputs to the summary generator 104 include a transcript 102, for example, a transcript of a conversation between two speakers (e.g., between a patient and a doctor). In some scenarios, the transcript 102 is a transcript of an audio memo generated by one speaker only (e.g., an insurance agent records audio describing an asset). For example, the transcript may be generated from an audio recording using a speech-to-text program. The outputs include a summary 106 that summarizes the transcript 102.

As depicted in FIG. 1, responsive to receiving the transcript 102, the summary generator 104 generates the summary 106. The summary 106 may include information summarizing a conversation documented by the transcript 102. The summary 106 may be formatted in sentence form, bulleted and/or numbered lists, and/or other formats. In some scenarios, the summary 106 may be a summary 106 of a legal deposition, a summary 106 of a transcript of a doctor-patient conversation that a doctor submits to an insurance company for reimbursement.

The entity extractor 108 may include a named entity recognition (NER) algorithm that detects entities 109 from within the text of the summary 106 and the transcript 102. The entities 109 may be important themes, concepts, values, or other entities detected by applying a named entity recognition (NER) to the summary 106 and the transcript 102. For example, the entities 109 in a doctor-patient conversation includes patient information, doctor information, symptoms, duration, and other entities. In some implementations, the entity extractor 108 may extract entities 109 within the summary 106 and within the transcript 102 corresponding to an ontology 118 or other knowledge-domain-specific information. In some implementations, extracting the entities 109 does not change the summary 106 or the transcript 102. The entity extractor 108 maps extracted output entities (e.g., entities extracted from the summary 106) to extracted input entities (e.g., entities extracted from the transcript). Mapped entities include entities that appear in both the extracted input entities and the extracted output entities. Unmapped entities include entities that appear in one of, but not both of, the extracted input entities and the extracted output entities. For example, unmapped input entities (e.g., omissions) are extracted from the transcript 102 but are not extracted from the summary 106 and unmapped output entities (e.g., hallucinations) are extracted from the summary 106 but are not extracted from the transcript 102.

The ontology 118 is a formal data structure that represents knowledge about a specific knowledge domain (e.g., medical diseases) that corresponds to the knowledge domain of the summary generator 104. The ontology 118 organizes entities (e.g., concepts) and properties of the entities (e.g., attributes, hierarchical relationships) in a structured way. For example, the ontology 118 may use a graph structure where nodes represent entities and edges represent properties. However, data structures (e.g., tables) other than a graph structure may be used to represent entities and properties. Properties may include hierarchical relationships. For example, class entities represent categories or types of objects in the knowledge domain and define a set of entities with common characteristics. An individual entity, also known as an instance, represents a single, concrete entity that belongs to a class. For example, a class (e.g., category) entity node may include one or multiple individual (e.g., instance) entity nodes within the class. In this example, the class entity may itself be an instance entity node of a higher class, and one or more of the instance entity nodes may also be a class entity node with further instance nodes within the class. Properties describe attributes (e.g., data properties) of class entities or individual entities and define relationships between them (e.g., object properties). For example, data properties specify characteristics or attributes of a class entity or individual entity and are associated with specific data values (e.g., numerical, textual, etc.). Object properties define relationships between individual entities. The ontology 118 may be structured hierarchically, where class entities are organized into superclass-subclass (e.g., parent-child) relationships. The ontology 118 may include logical statements or axioms that define how class entities, individual entities, and properties interact. For example, the ontology 118 may correspond to a medical diagnosis knowledge domain and require that every instance entity of a disease class entity have a relationship to at least one instance entity of the symptoms class entity. In some implementations, detected output entities (e.g., entities detected in the summary 106) and detected input entities (e.g., entities detected in the transcript 102) may be matched to ontology 118 entities using a matching algorithm. The matching algorithm may assign a matching score to an ontology entity for a detected input entity or detected output entity using a lemmatization and string match approach and then linking the detected input entity or detected output entity to the ontology entity based on the matching score (e.g., responsive to determining that the matching score is greater than a threshold matching score). The ontology 118 is one example of knowledge-domain-specific information, and other data (e.g., tables, graphs, or other data) may be used instead of an ontology 118 in some implementations.

The corrective feedback solicitor 111 generates, using the entities 109, the summary 106, and the transcript 102, a linked entity list 110. The linked entity list 110 may include a list of the unique entities of the entities 109 that are detected in the summary 106 and in the transcript 102. In some implementations, the linked entity list 110 may include a correspondence type for each of the unique entities, for example, an omitted type indicating that the entity is present in the transcript 102 but not in the summary 106, a hallucinated type indicating that the entity is not present in the transcript 102 but is present in the summary 106, and a corresponding type that indicates that the entity is present both in the transcript 102 and in the summary 106. The corrective feedback solicitor 111 may highlight or otherwise indicate (e.g., using shading, a color scheme, etc.) the omitted type and hallucinated type entities as potential quality issues of the summary 106.

The corrective feedback solicitor 111 may receive corrective feedback 112 to the linked entity list 110. For example, the corrective feedback solicitor 111 presents the linked entity list 110 via a user interface, and a user (e.g., a reviewer of the summary 106) may receive the corrective feedback 112 to the linked entity list 110 via the user interface. The corrective feedback 112 may include the acceptance or rejection of one or more omitted-type entities (e.g., entities detected in the transcript 102 but not detected in the summary 106), the acceptance or rejection of one or more hallucinated-type entities (e.g., entities detected in the summary 106 but not detected in the transcript 102), and the acceptance or rejection of one or more corresponding-type entities (e.g., entities detected both in the summary 106 and in the transcript 102). In some implementations, the corrective feedback 112 includes an edit to an entity, for example, the reviewer provides an input that changes a spelling of the entity or otherwise changes the wording of the entity. In some implementations, the corrective feedback solicitor 111 may receive corrective feedback 112 to the summary 106, for example, one or more deletions of text from or additions of text to the summary 106. In some implementations, the corrective feedback solicitor 111 may receive corrective feedback 112 to the transcript 102, but in some implementations, the corrective feedback solicitor 111 does not allow corrective feedback to the transcript 102, for example, as may be specified by legal requirements or best practices.

The inputs generator 114 generates inputs 116 for the summary generator 104 to regenerate the summary 106 based on the received corrective feedback 112 to the linked entity list 110. The corrective inputs 116 may include a prompt to the summary generator 104 to regenerate the summary 106, for example, to correct the summary 106 given the prompt. For example, the corrective feedback 112 includes a rejection of a hallucination entity “A” of the linked entity list 110, and the inputs generator 114 generates a corrective inputs 116 including a prompt that states, “regenerate this summary and be sure to exclude “A” that was not present in the input transcript but was included the summary.” In this example, the corrective feedback 112 also includes an acceptance of an omission entity B of the linked entity list 110, and the inputs generator 114 generates a prompt that states, “regenerate this summary and be sure to include “B” that was present in the input transcript but not in the summary.” The summary generator 104 incorporates the corrective inputs 116 into a context window that includes the transcript 102, the summary 106, and the corrective inputs 116. In some implementations, the inputs generator 114 retrains the summary generator 104 based on the corrective feedback 112, for example, by modifying one or more weights or other parameters of the summary generator 104.

The summary generator 104 regenerates the summary 106 by providing outputs based on the corrective inputs 116. Regenerating the summary 106 may involve generating a new summary or editing the summary 106 to yield the outputs. In some implementations, the summary generator 104 may, responsive to receiving an input of the reviewer, publish, store, or transmit the regenerated summary. For example, the reviewer verified the regenerated summary as accurate and ready for publication. For example, the regenerated summary is uploaded to an insurance database as a verified summary of a medical examination.

In these implementations, subsequent iterations of generating a subsequent linked entity list by the entity extractor 108, receiving subsequent corrective feedback on the subsequent linked entity list at the inputs generator 114, generating subsequent inputs at the inputs generator 114, and outputting subsequent regenerated summaries at the summary generator 104 based on the subsequent inputs may be performed until the reviewer approves a finalized subsequent regenerated summary. For example, the entity extractor 108 may generate a subsequent linked entity list from the regenerated summary. In these implementations, the inputs generator 114 may receive subsequent corrective feedback of the subsequent linked entity list and generate subsequent inputs based on the subsequent corrective feedback. The subsequent inputs may be inputted to the summary generator, which outputs a subsequent regenerated summary based on the inputs.

In some implementations, image data, audio data, or other input data is used for input to the summary generator 104 instead of a textual transcript 102. In these implementations, the summary 106 includes identified features within the input data (e.g., image data, audio data, or other data). The entities 109 in these implementations may include input entities including regions of interest (e.g., identified pixels) within the input data and output entities that are textual entities in the summary 106. The entity extractor 108, in these implementations, may use an image recognition algorithm to detect the input entities and to derive a textual description of the input entities. The textual description of the input entities may be compared to the output entities detected in the textual summary 106 to determine which entities are omission entities, hallucination entities, and corresponding entities.

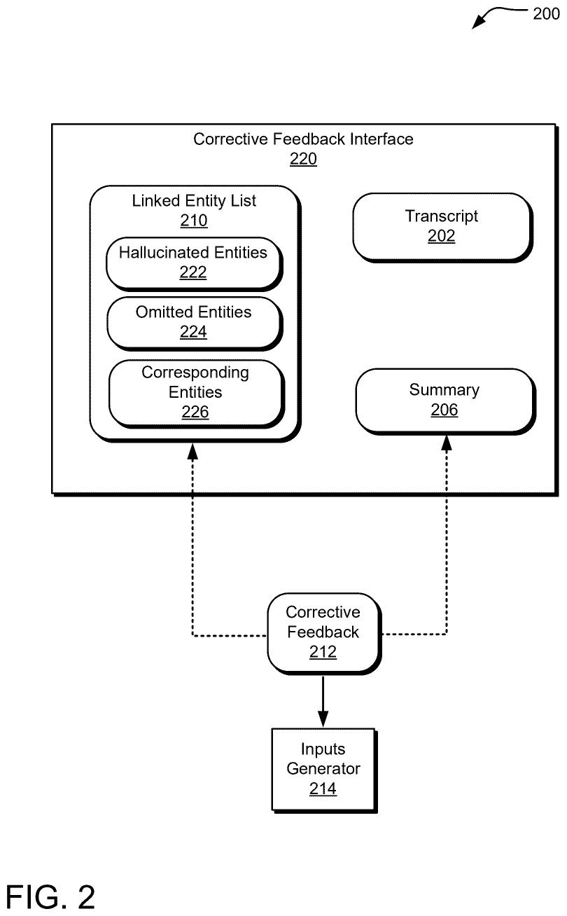

FIG. 2 illustrates an example computing environment 200 for presenting, via a corrective feedback interface 220, a linked entity list 210, and receiving corrective feedback to the linked entity list 210 via the corrective feedback interface 220 to provide to an inputs generator 214. The corrective feedback interface 220 may present the linked entity list 210, the transcript 202, and the summary 206 in corresponding portions (e.g., via panes, etc.) of the corrective feedback interface 220. The corrective feedback interface 220 may be displayed via a user computing device of the reviewer.

The linked entity list 210 includes a list of entities (e.g., including, in some implementations, entities of an ontology) that are detected in a summary 206 and in a transcript 202. For example, a summary generator generates an output including the summary 206 from inputs including the transcript 202. In some implementations, the linked entity list 210 may include a correspondence type for each of the entities. The entities may include omitted entities 224, hallucinated entities 222, and corresponding entities 226. The omitted entities 224 are detected in the transcript 202 (e.g., using the NER algorithm) but are not detected in the summary 206. The hallucinated entities 222 are not detected in the transcript 202 (e.g., using the NER algorithm) but are detected in the summary 206. The corresponding entities 226 are detected (e.g., using the NER algorithm) both in the transcript 202 and in the summary 206. In some implementations, the entities may be organized further by category. For example, the corresponding entities 226 may be organized into “patient information” and “subjective” categories. In some implementations, the linked entity list 210 highlights or otherwise emphasizes the hallucinated entities 222 and the omitted entities 224 as quality issues.

As depicted in FIG. 2, the example linked entity list 210 links the entities (e.g., hallucinated entities 222, omitted entities 224, and corresponding entities 226) to corresponding portions of the transcript 202 and the summary 206 in which the entities were detected. For example, the corrective feedback interface 220 may display at least a portion of the transcript 202 and at least a portion of the summary 206, for example, in corresponding portions (e.g., panes) of the corrective feedback interface 220. Responsive to receiving a selection of an entity of the entities in the linked entity list 210, the corrective feedback interface 220 may emphasize (e.g., via highlighting, bolding, italicizing, underlining, increasing a font size, etc.) a context of the entity in the transcript 202 and/or the summary 206. The context may be a word including the entity itself, a sentence including the entity, a paragraph including the entity, or a phrase including the entity (e.g., the entity and a predefined number of neighboring words).

The reviewer may provide corrective feedback 212 to the linked entity list 210, for example, by accepting or rejecting one or more of the entities by providing input to the corrective feedback interface 220. For example, the reviewer may accept or reject one or more of the hallucinated entities 222, the omitted entities 224, or the corresponding entities 226. For example, the corrective feedback interface 220 may display each of the entities along with one or more interface objects, for example, a corresponding checkbox that may be selected and unselected, or a corresponding pair of confirm and delete objects. In some implementations, the corrective feedback interface 220 enables confirmation or rejection of any of the entities of the linked entity list 210. In some implementations, the corrective feedback interface 220 enables confirmation and/or rejection of the hallucinated entities 222 and the omitted entities 224 only. In some implementations, the corrective feedback interface 220 enables rejection only of one or more entities. In some implementations, any entities that are not rejected are deemed accepted by the reviewer. In some implementations, all entities must either be accepted or rejected by the reviewer before the summary 206 may be regenerated or a finalized summary 206 outputted. In some implementations, all hallucinated entities 222 and omitted entities 224 must either be accepted or rejected by the reviewer before the summary 206 may be regenerated or a finalized summary 206 outputted.

In some implementations, the corrective feedback interface 220 enables the reviewer to provide corrective feedback 212 to the summary 206 directly. For example, the reviewer to add text, delete text, or perform other editing operations directly to the summary 206.

Based on the received corrective feedback 212 (e.g., confirmation and/or rejection of one or more entities of the linked entity list 210 and/or edits to the summary 206), the inputs generator 214 generates inputs for regenerating the summary 206. The inputs may be a prompt to the summary generator that includes a request to regenerate the summary 206 based on the corrective feedback 212. For example, the reviewer rejects entity A from the hallucinated entities 222, accepts entity B from the omitted entities 224, and deletes the third sentence from the summary 206. In this example, the prompt generated based on the corrective feedback 212 reads, “regenerate the summary but remove any mention of entity A, add discussion of entity B that was included in the transcript, and delete sentence 3 from the summary.” The inputs are provided to the summary generator to generate summary 206.

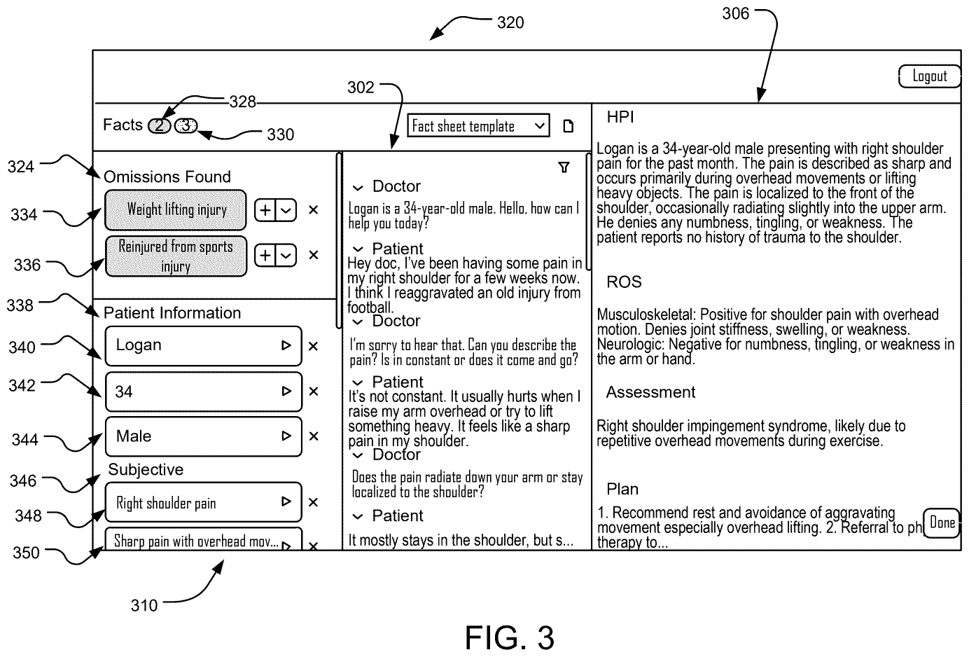

FIG. 3 illustrates an example corrective feedback interface 320 for receiving corrective feedback to a linked entity list 310. The corrective feedback interface 320 is one example of a corrective feedback interface. The information of the corrective feedback interface 320 may be displayed in a different format or layout than as depicted in the example corrective feedback interface 320.

The example corrective feedback interface 320 displays a linked entity list 310 that links entities to corresponding portions of a transcript 302 and a summary 306 in which the entities were detected. For example, the corrective feedback interface 320 displays the linked entity list 310 in the left pane, the transcript 302 in the center pane, and the summary 306 in the right pane of the corrective feedback interface 320. The example linked entity list 310 displays entity 334, entity 336, entity 340, entity 342, entity 344, entity 348, and entity 350. Entity 334 (“weightlifting injury”) and entity 336 (“reinjured from sports injury”) are displayed within an omitted entities 324 category (which reads “omissions found”) and are indicated via shading to alert the reviewer. For example, the omitted entities 324 are entities detected within the transcript 302 but not detected in the summary 306. The reviewer may select interface object 328 to view the omitted entities 324, and the interface object 328 displays a count (“2”) of the omitted entities 324. The interface object 330 is selectable by the reviewer to display additional entities (e.g., entities that are detected in the summary 306 but not in the transcript 302) and also displays a count (“3”) of the number of the additional entities. The non-shaded entities (e.g., entity 340, entity 342, entity 344, entity 348, and entity 350) are corresponding entities that were detected in both the transcript 302 and in the summary 306. The entity 340 (“Logan”), entity 342 (“34”), and entity 344 (“Male”) are displayed within a patient information 338 category. The entity 348 (“Right shoulder pain”) and the entity 350 (“sharp pain with overhead movement”) are displayed within a subjective 346 category.

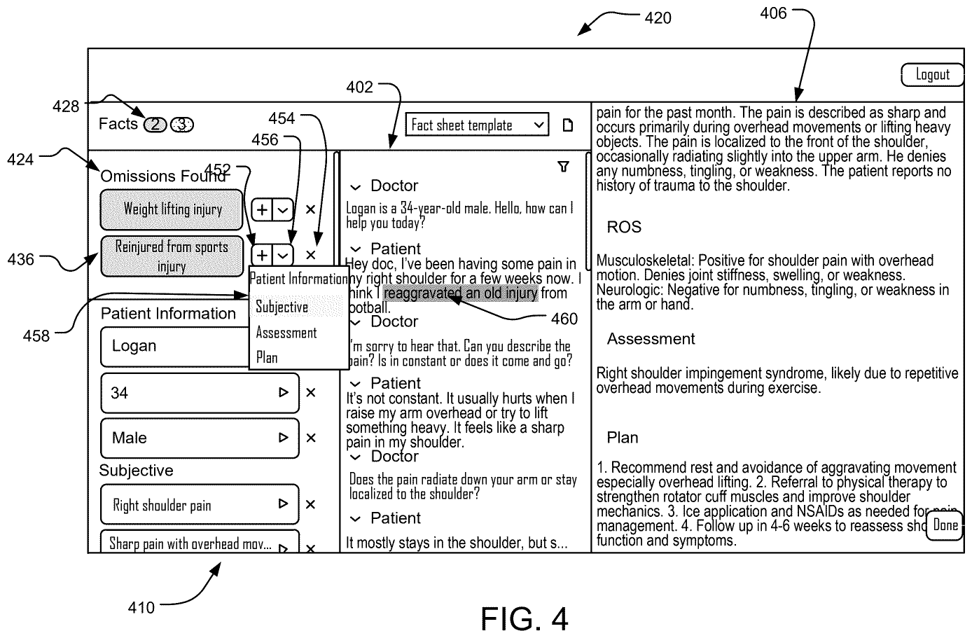

FIG. 4 illustrates an example of corrective feedback interface 420 for receiving corrective feedback to a linked entity list. The corrective feedback interface 420 is one example of a corrective feedback interface. The information of the corrective feedback interface 420 may be displayed in a different format or layout than as depicted in the example corrective feedback interface 420.

The example corrective feedback interface 420 displays a linked entity list 410 that links entities to corresponding portions of a transcript 402 and a summary 406 in which the entities were detected. For example, the corrective feedback interface 420 displays the linked entity list 410 in the left pane, the transcript 402 in the center pane, and the summary 406 in the right pane of the corrective feedback interface 420. The example linked entity list 410 displays entities within an omitted entities 424 category (which reads “omissions found”) and are indicated via shading to alert the reviewer. The reviewer may select interface object 428 to view the omitted entities 424, and the interface object 428 displays a count (“2”) of the omitted entities 424. For example, the omitted entities 424 are a first entity that reads “weightlifting injury” and entity 436, which reads “reinjured from sports injury.” For example, the omitted entities 424 are entities detected within the transcript 402 but not detected in the summary 406.

The reviewer may accept the entity 436 by selecting interface object 452 and may reject the entity 436 by selecting the interface object 454.

Responsive to receiving a selection of the entity 436 (“reinjured from sports injury”) via the corrective feedback interface 420, the corrective feedback interface 420 highlights a context 460 of the transcript 402 that includes the entity 436. For example, responsive to the selection of the entity 436, the corrective feedback interface highlights a portion of a sentence from the transcript 402 that reads “reaggravated an old injury from football.” Responsive to receiving a selection of interface object 456 corresponding to the entity 436, the corrective feedback interface 420 displays a category selection menu 458 that enables the reviewer to assign the entity 436 to a category of a set of categories, for example, to the “subjective” category as selected (e.g., shown via shading) from the “patient information,” “subjective,” “assessment,” and “plan” category options displayed in the example corrective feedback interface 420.

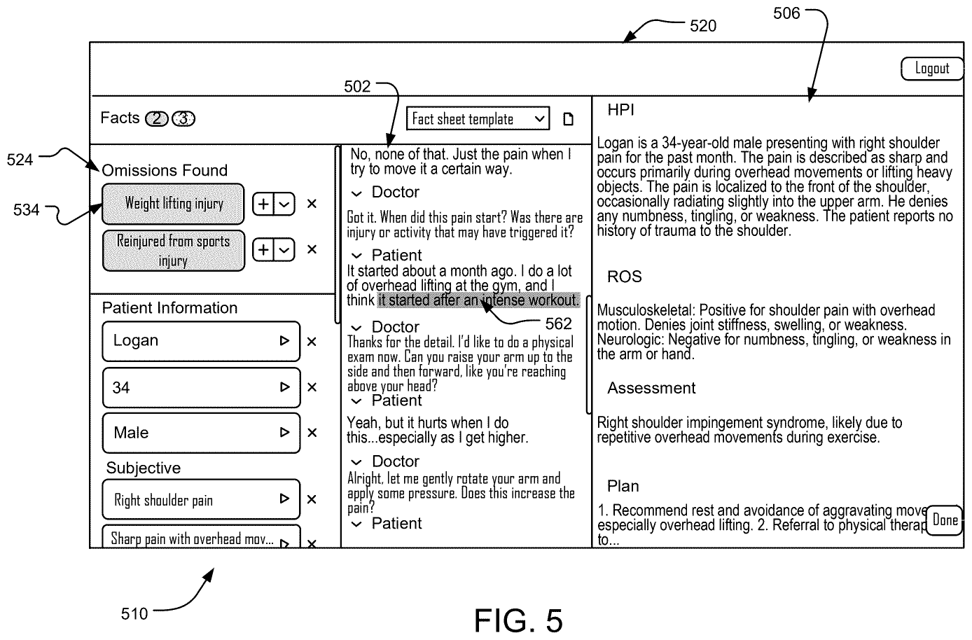

FIG. 5 illustrates an example of corrective feedback interface 520 for receiving corrective feedback to a linked entity list. The corrective feedback interface 520 is one example of a corrective feedback interface. The information of the corrective feedback interface 520 may be displayed in a different format or layout than as depicted in the example corrective feedback interface 520.

The example corrective feedback interface 520 displays a linked entity list 510 that links entities to corresponding portions of a transcript 502 and a summary 506 in which the entities were detected. For example, the corrective feedback interface 520 displays the linked entity list 510 in the left pane, the transcript 502 in the center pane, and the summary 506 in the right pane of the corrective feedback interface 520. The example linked entity list 510 displays entities within an omitted entities 524 category (which reads “omissions found”) and is indicated via shading to alert the reviewer. For example, the omitted entities 524 are entity 534, which reads “weightlifting injury,” and another entity, which reads “reinjured from a sports injury.” For example, the omitted entities 524 are entities detected within the transcript 502 but not detected in the summary 506.

Responsive to receiving a selection of the entity 534 (“weight lifting injury”) via the corrective feedback interface 520, the corrective feedback interface 520 highlights a context 562 of the transcript 502 that includes the entity 534. For example, responsive to the selection of entity 534, the corrective feedback interface highlights a portion of a sentence from transcript 502 that reads, “It started after an intense workout.”

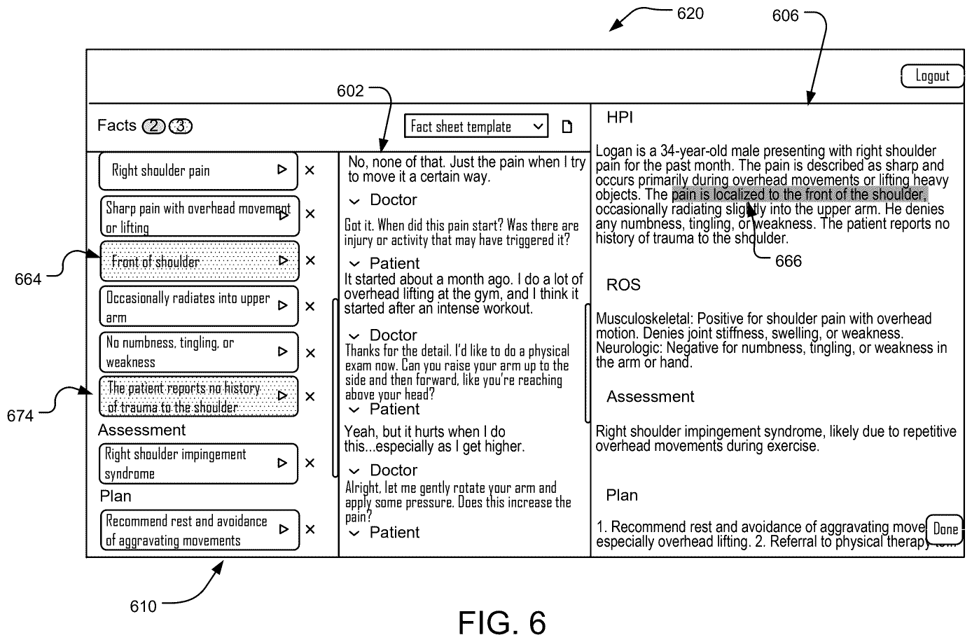

FIG. 6 illustrates an example of corrective feedback interface 620 for receiving corrective feedback to a linked entity list. The corrective feedback interface 620 is one example of a corrective feedback interface. The information of the corrective feedback interface 620 may be displayed in a different format or layout than as depicted in the example corrective feedback interface 620.

The example corrective feedback interface 620 displays a linked entity list 610 that links entities to corresponding portions of a transcript 602 and a summary 606 in which the entities were detected. For example, the corrective feedback interface 620 displays the linked entity list 610 in the left pane, the transcript 602 in the center pane, and the summary 606 in the right pane of the corrective feedback interface 620. The example linked entity list 610 indicates entities within an added entities category via shading to alert the reviewer. For example, the added entities include entity 664, which reads “front of the shoulder,” and entity 674, which reads “the patient reports no history of trauma to the shoulder,” both of which are shaded to alert the user of the addition (e.g., both entities are hallucinations and are present in the summary 606 but not in the transcript 602).

Responsive to receiving a selection of the entity 664 (“front of shoulder”) via the corrective feedback interface 620, the corrective feedback interface 620 highlights a context 666 of the summary 606 that includes the entity 664. For example, responsive to the selection of entity 664, the corrective feedback interface highlights a portion of a sentence from summary 606 that reads, “Pain is localized to the front of the shoulder.”

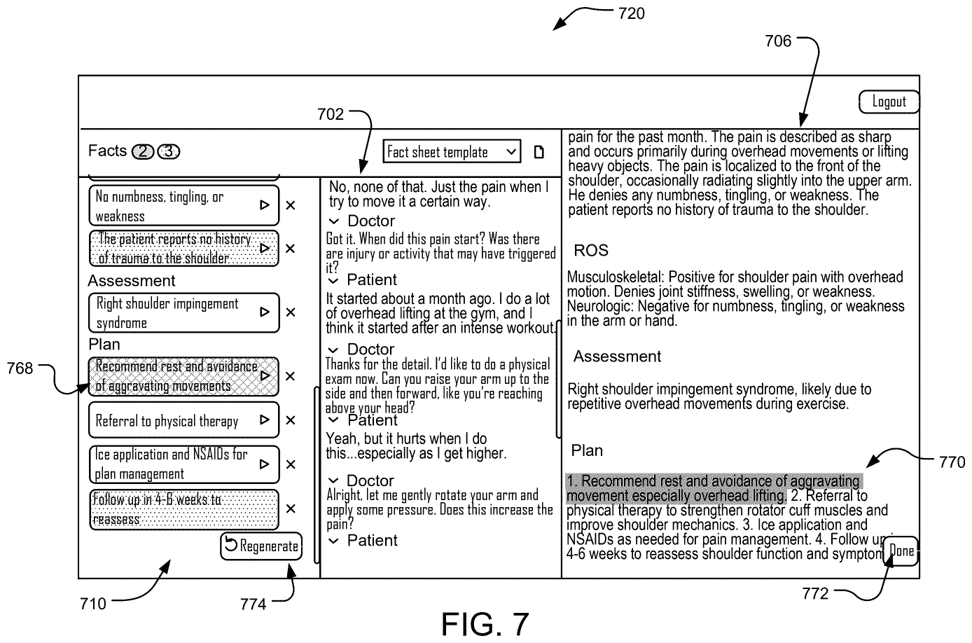

FIG. 7 illustrates an example corrective feedback interface 720 for receiving corrective feedback to a linked entity list. The corrective feedback interface 720 is one example of a corrective feedback interface. The information of the corrective feedback interface 720 may be displayed in a different format or layout than as depicted in the example corrective feedback interface 720.

The example corrective feedback interface 720 displays a linked entity list 710 that links entities to corresponding portions of a transcript 702 and a summary 706 in which the entities were detected. For example, the corrective feedback interface 720 displays the linked entity list 710 in the left pane, the transcript 702 in the center pane, and the summary 706 in the right pane of the corrective feedback interface 720.

Responsive to Receiving a Selection of the entity 768 (“recommend rest and avoidance of aggravating movements”) via the corrective feedback interface 720, the corrective feedback interface 720 highlights a context 770 of the summary 706 that includes the entity 768. For example, responsive to the selection of the entity 768, the corrective feedback interface highlights a portion of a sentence from the summary 706 that reads “1. Recommend rest and avoidance of aggravating movements especially overhead lifting.”

Responsive to receiving a selection of the interface object 774 (“which reads “Regenerate”), the summary 706 and the linked entity list 710 are regenerated by a summary generator and an entity extractor, respectively. Responsive to the selection of interface object 772 (which reads “Done”), the reviewer indicates that no further feedback will be provided.

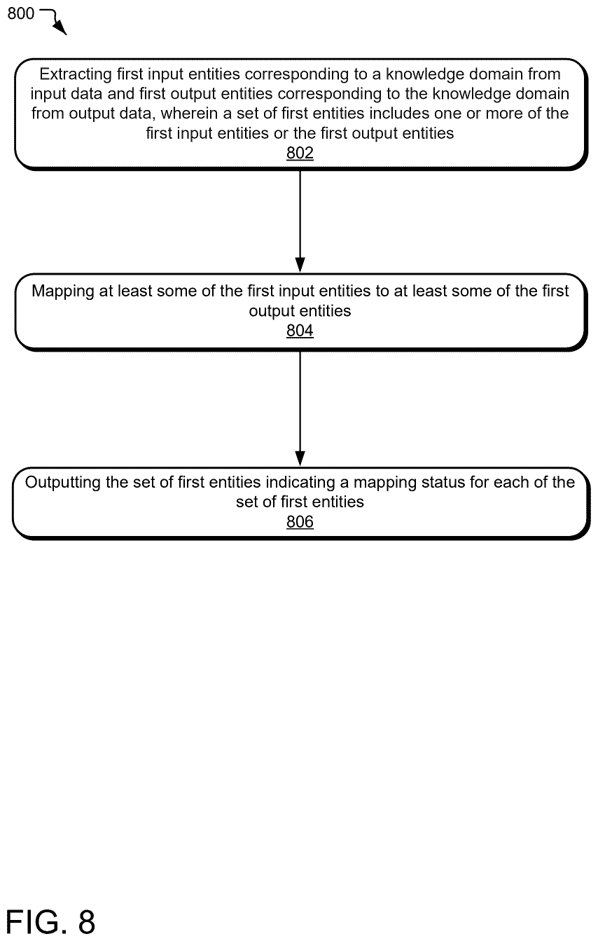

FIG. 8 depicts examples of operations 800 for processing output data generated by an artificial intelligence model from input data. The example operations 800 are, in some implementations, performed by one or more of a summary generator, an entity extractor, a corrective feedback solicitor, and an inputs generator with characteristics the same or similar as described herein with respect to FIG. 1.

An example extracting operation 802 extracts first input entities corresponding to the knowledge domain from the input data and first output entities corresponding to the knowledge domain from the output data, wherein a set of first entities includes one or more of the first input entities or the first output entities. In some implementations, one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities. In some implementations, the input data includes a transcript of a conversation and the output data includes a summary of the transcript. In some implementations, the first input entities and the first output entities are extracted using an ontology.

An example mapping operation 804 maps at least some of the first input entities to at least some of the first output entities.

An example outputting operation 806 outputs the set of first entities indicating a mapping status for each of the set of first entities.. In some implementations, corrective feedback to the set of first entities is received including removing one or more of the one or more unmapped entities from the set of first entities to generate an updated set of first entities. In some implementations, receiving corrective feedback to the set of first entities including removing one or more of the one or more unmapped entities from the set of first entities to generate an updated set of first entities. In some implementations, the set of first entities is presented in a corrective feedback user interface, corrective feedback to the set of first entities is received via the corrective feedback user interface, and updated output data is generated based on the received corrective feedback. In some implementations, corrective input data is generated for the artificial intelligence model from the received corrective feedback, the corrective input data is input to the artificial intelligence model, and the updated output data is received from the artificial intelligence model, the updated output data being generated by the artificial intelligence model based on the input data, the output data, and the corrective input data

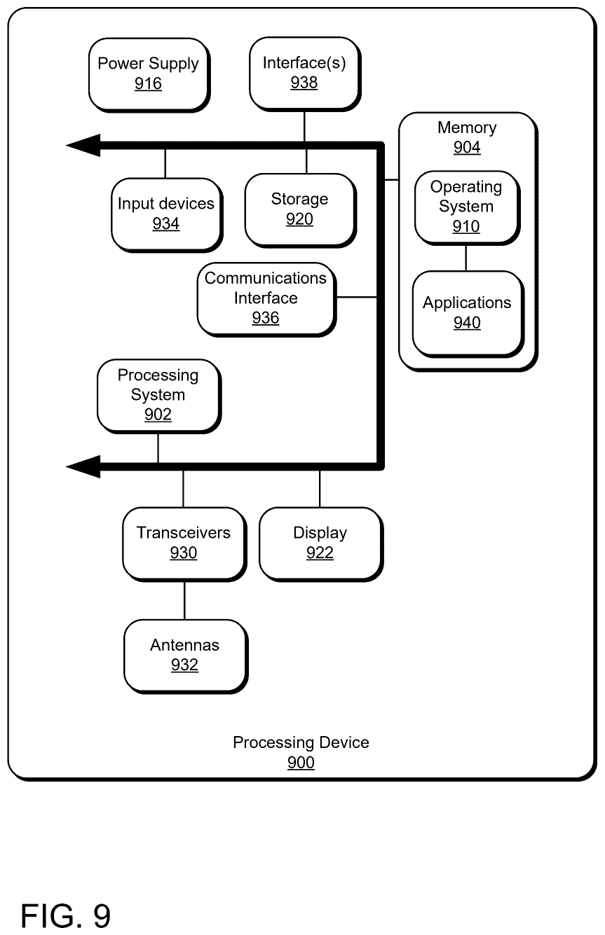

FIG. 9 illustrates an example computing device 900 for use in implementing the described technology. The computing device 900 may be a client computing device (such as a laptop computer, a desktop computer, or a tablet computer), a server/cloud computing device, an Internet-of-Things (IoT), any other type of computing device, or a combination of these options. The computing device 900 includes one or more hardware processor(s) 902 and a memory 904. The memory 904 generally includes both volatile memory (e.g., RAM) and nonvolatile memory (e.g., flash memory), although one or the other type of memory may be omitted. An operating system 910 resides in the memory 904 and is executed by the processor(s) 902. In some implementations, the computing device 900 includes and/or is communicatively coupled to storage 920.

In the example computing device 900, as shown in FIG. 9, one or more software modules, segments, and/or processors, such as applications 940, a summary generator, an entity extractor, an inputs generator, a corrective feedback interface, and other program code and modules are loaded into the operating system 910 on the memory 904 and/or the storage 920 and executed by the processor(s) 902. The storage 920 may store entities, a linked entity list, additional entities, omitted entities, corresponding entities, entity categories, a transcript, a summary, corrective feedback, an ontology, inputs, a language model, and other data and be local to the computing device 900 or may be remote and communicatively connected to the computing device 900. In particular, in one implementation, components of a system for processing output data generated by an artificial intelligence model from input data may be implemented entirely in hardware or in a combination of hardware circuitry and software.

The computing device 900 includes a power supply 916, which may include or be connected to one or more batteries or other power sources and which provides power to other components of the computing device 900. The power supply 916 may also be connected to an external power source that overrides or recharges the built-in batteries or other power sources.

The computing device 900 may include one or more communication transceivers 930, which may be connected to one or more antenna(s) 932 to provide network connectivity (e.g., mobile phone network, Wi-Fi®, Bluetooth®) to one or more other servers, client devices, IoT devices, and other computing and communications devices. The computing device 900 may further include a communications interface 936 (such as a network adapter or an I/O port, which are types of communication devices). The computing device 900 may use the adapter and any other types of communication devices for establishing connections over a wide-area network (WAN) or local-area network (LAN). It should be appreciated that the network connections shown are exemplary and that other communications devices and means for establishing a communications link between the computing device 900 and other devices may be used.

The computing device 900 may include one or more input devices 934 such that a user may enter commands and information (e.g., a keyboard, trackpad, or mouse). These and other input devices may be coupled to the server by one or more interfaces 938, such as a serial port interface, parallel port, or universal serial bus (USB). The computing device 900 may further include a display 922, such as a touchscreen display.

The computing device 900 may include a variety of tangible processor-readable storage media and intangible processor-readable communication signals. Tangible processor-readable storage can be embodied by any available media that can be accessed by the computing device 900 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 900. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of processing output data generated by an artificial intelligence model from input data, wherein the output data and the input data are associated with a knowledge domain, the method comprising: extracting first input entities corresponding to the knowledge domain from the input data and first output entities corresponding to the knowledge domain from the output data, wherein a set of first entities includes one or more of the first input entities or the first output entities; mapping at least some of the first input entities to at least some of the first output entities; and outputting the set of first entities indicating a mapping status for each of the set of first entities.

Clause 2. The method of clause 1, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

Clause 3. The method of clause 2, further comprising: receiving corrective feedback to the set of first entities including removing one or more of the one or more unmapped entities from the set of first entities to generate an updated set of first entities.

Clause 4. The method of clause 1, further comprising: presenting the set of first entities in a corrective feedback user interface; receiving corrective feedback to the set of first entities via the corrective feedback user interface; and generating updated output data based on the received corrective feedback.

Clause 5. The method of clause 4, wherein generating the updated output data includes: generating corrective input data for the artificial intelligence model from the received corrective feedback; inputting the corrective input data to the artificial intelligence model; and receiving the updated output data from the artificial intelligence model, the updated output data being generated by the artificial intelligence model based on the input data, the output data, and the corrective input data.

Clause 6. The method of clause 1, the input data comprising a transcript of a conversation, the output data comprising a summary of the transcript.

Clause 7. The method of clause 1, wherein the first input entities and the first output entities are extracted using an ontology.

Clause 8. A system for processing output data generated by an artificial intelligence model from input data, wherein the output data and the input data are associated with a knowledge domain, the system comprising: one or more hardware processors; a memory; an entity extractor storable in the memory, executable by the one or more hardware processors, and configured to perform operations comprising: extracting first input entities corresponding to the knowledge domain from the input data and first output entities corresponding to the knowledge domain from the output data, wherein a set of first entities includes one or more of the first input entities or the first output entities; and mapping at least some of the first input entities to at least some of the first output entities; and a corrective feedback solicitor storable in the memory, executable by the one or more hardware processors, and configured to perform operations comprising outputting the set of first entities indicating a mapping status for each of the set of first entities.

Clause 9. The system of clause 8, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

Clause 10. The system of clause 8, the corrective feedback solicitor further configured to perform operations comprising: receiving corrective feedback to the set of first entities including removing one or more unmapped entities from the set of first entities to generate an updated set of first entities.

Clause 11. The system of clause 8, the corrective feedback solicitor further configured to perform operations comprising: presenting the set of first entities in a corrective feedback user interface; receiving corrective feedback to the set of first entities via the corrective feedback user interface; and further comprising a summary generator storable in the memory, executable by the one or more hardware processors, and configured to perform operations comprising generating updated output data based on the received corrective feedback.

Clause 12. The system of clause 11, further comprising: an inputs generator storable in the memory, executable by the one or more hardware processors, and configured to perform operations comprising: generating corrective input data for the artificial intelligence model from the received corrective feedback; and inputting the corrective input data to the artificial intelligence model; and a summary generator storable in the memory, executable by the one or more hardware processors, and configured to perform operations comprising receiving the updated output data from the artificial intelligence model, the updated output data being generated by the artificial intelligence model based on the input data, the output data, and the corrective input data.

Clause 13. The system of clause 8, the input data comprising a transcript of a conversation, the output data comprising a summary of the transcript.

Clause 14. The system of clause 8, wherein the first input entities and the first output entities are extracted using an ontology.

Clause 15. One or more tangible processor-readable storage media embodied with instructions for executing on one or more processors and circuits of a computing device a process for processing output data generated by an artificial intelligence model from input data, wherein the output data and the input data are associated with a knowledge domain, the process comprising: extracting first input entities corresponding to the knowledge domain from the input data and first output entities corresponding to the knowledge domain from the output data, wherein a set of first entities includes one or more of the first input entities or the first output entities; mapping at least some of the first input entities to at least some of the first output entities; ; and outputting the set of first entities indicating a mapping status for each of the set of first entities.

Clause 16. The one or more tangible processor-readable storage media of clause 15, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

Clause 17. The one or more tangible processor-readable storage media of clause 15, the process further comprising: receiving corrective feedback to the set of first entities including removing one or more unmapped entities from the set of first entities to generate an updated set of first entities.

Clause 18. The one or more tangible processor-readable storage media of clause 15, the process further comprising: presenting the set of first entities in a corrective feedback user interface; receiving corrective feedback to the set of first entities via the corrective feedback user interface; and generating updated output data based on the received corrective feedback.

Clause 19. The one or more tangible processor-readable storage media of clause 18, wherein generating the updated output data includes: generating corrective input data for the artificial intelligence model from the received corrective feedback; inputting the corrective input data to the artificial intelligence model; and receiving the updated output data from the artificial intelligence model, the updated output data being generated by the artificial intelligence model based on the input data, the output data, and the corrective input data.

### Clause 20. the One or More Tangible Processor-readable

storage media of clause 15, the input data comprising a transcript of a conversation, the output data comprising a summary of the transcript.

Clause 21. A system of processing output data generated by an artificial intelligence model from input data, wherein the output data and the input data are associated with a knowledge domain, the method comprising: means for extracting first input entities corresponding to the knowledge domain from the input data and first output entities corresponding to the knowledge domain from the output data, wherein a set of first entities includes one or more of the first input entities or the first output entities; means for mapping at least some of the first input entities to at least some of the first output entities; and means for outputting the set of first entities indicating a mapping status for each of the set of first entities.

Clause 22. The system of clause 21, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

Clause 23. The system of clause 22, further comprising: means for receiving corrective feedback to the set of first entities including means for removing one or more of the one or more unmapped entities from the set of first entities to generate an updated set of first entities.

Clause 24. The system of clause 21, further comprising: means for presenting the set of first entities in a corrective feedback user interface; receiving corrective feedback to the set of first entities via the corrective feedback user interface; and means for generating updated output data based on the received corrective feedback.

### Clause 25. the System of Clause 24, Wherein

the means for generating the updated output data includes: means for generating corrective input data for the artificial intelligence model from the received corrective feedback; means for inputting the corrective input data to the artificial intelligence model; and means for receiving the updated output data from the artificial intelligence model, the updated output data being generated by the artificial intelligence model based on the input data, the output data, and the corrective input data.

Clause 26. The method of clause 21, the input data comprising a transcript of a conversation, the output data comprising a summary of the transcript.

### Clause 27. the Method of Clause 21, Wherein

the first input entities and the first output entities are extracted using an ontology.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of processing output data generated by an artificial intelligence model from input data, wherein the output data and the input data are associated with a knowledge domain, the method comprising:
extracting first input entities corresponding to the knowledge domain from the input data and first output entities corresponding to the knowledge domain from the output data, wherein a set of first entities includes one or more of the first input entities or the first output entities;
mapping at least some of the first input entities to at least some of the first output entities; and
outputting the set of first entities indicating a mapping status for each of the set of first entities.

2. The method of claim 1, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

3. The method of claim 2, further comprising:
receiving corrective feedback to the set of first entities including removing one or more of the one or more unmapped entities from the set of first entities to generate an updated set of first entities.

4. The method of claim 1, further comprising:
presenting the set of first entities in a corrective feedback user interface;
receiving corrective feedback to the set of first entities via the corrective feedback user interface; and
generating updated output data based on the received corrective feedback.

5. The method of claim 4, wherein generating the updated output data includes:
generating corrective input data for the artificial intelligence model from the received corrective feedback;
inputting the corrective input data to the artificial intelligence model; and
receiving the updated output data from the artificial intelligence model, the updated output data being generated by the artificial intelligence model based on the input data, the output data, and the corrective input data.

6. The method of claim 1, the input data comprising a transcript of a conversation, the output data comprising a summary of the transcript.

7. The method of claim 1, wherein the first input entities and the first output entities are extracted using an ontology.

8. A system for processing output data generated by an artificial intelligence model from input data, wherein the output data and the input data are associated with a knowledge domain, the system comprising:
one or more hardware processors;
a memory;
an entity extractor storable in the memory, executable by the one or more hardware processors, and configured to perform operations comprising:
extracting first input entities corresponding to the knowledge domain from the input data and first output entities corresponding to the knowledge domain from the output data, wherein a set of first entities includes one or more of the first input entities or the first output entities; and
mapping at least some of the first input entities to at least some of the first output entities; and
a corrective feedback solicitor storable in the memory, executable by the one or more hardware processors, and configured to perform operations comprising outputting the set of first entities indicating a mapping status for each of the set of first entities.

9. The system of claim 8, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

10. The system of claim 8, the corrective feedback solicitor further configured to perform operations comprising:
receiving corrective feedback to the set of first entities including removing one or more unmapped entities from the set of first entities to generate an updated set of first entities.

11. The system of claim 8, the corrective feedback solicitor further configured to perform operations comprising:
presenting the set of first entities in a corrective feedback user interface;
receiving corrective feedback to the set of first entities via the corrective feedback user interface; and
further comprising a summary generator storable in the memory, executable by the one or more hardware processors, and configured to perform operations comprising generating updated output data based on the received corrective feedback.

12. The system of claim 11, further comprising:
an inputs generator storable in the memory, executable by the one or more hardware processors, and configured to perform operations comprising:
generating corrective input data for the artificial intelligence model from the received corrective feedback; and
inputting the corrective input data to the artificial intelligence model; and
a summary generator storable in the memory, executable by the one or more hardware processors, and configured to perform operations comprising receiving the updated output data from the artificial intelligence model, the updated output data being generated by the artificial intelligence model based on the input data, the output data, and the corrective input data.

13. The system of claim 8, the input data comprising a transcript of a conversation, the output data comprising a summary of the transcript.

14. The system of claim 8, wherein the first input entities and the first output entities are extracted using an ontology.

15. One or more tangible processor-readable storage media embodied with instructions for executing on one or more processors and circuits of a computing device a process for processing output data generated by an artificial intelligence model from input data, wherein the output data and the input data are associated with a knowledge domain, the process comprising:
extracting first input entities corresponding to the knowledge domain from the input data and first output entities corresponding to the knowledge domain from the output data, wherein a set of first entities includes one or more of the first input entities or the first output entities;
mapping at least some of the first input entities to at least some of the first output entities;
; and
outputting the set of first entities indicating a mapping status for each of the set of first entities.

16. The one or more tangible processor-readable storage media of claim 15, wherein one or more of the first input entities or the first output entities remain unmapped as one or more unmapped entities and further comprising identifying the one or more unmapped entities among the set of first entities as possible quality issues, the possible quality issues including one or more omitted entities of the first input entities comprising unmapped first input entities and one or more hallucinated entities of the first output entities comprising unmapped first output entities.

17. The one or more tangible processor-readable storage media of claim 15, the process further comprising:
receiving corrective feedback to the set of first entities including removing one or more unmapped entities from the set of first entities to generate an updated set of first entities.

18. The one or more tangible processor-readable storage media of claim 15, the process further comprising:
presenting the set of first entities in a corrective feedback user interface;
receiving corrective feedback to the set of first entities via the corrective feedback user interface; and
generating updated output data based on the received corrective feedback.

19. The one or more tangible processor-readable storage media of claim 18, wherein generating the updated output data includes:
generating corrective input data for the artificial intelligence model from the received corrective feedback;
inputting the corrective input data to the artificial intelligence model; and
receiving the updated output data from the artificial intelligence model, the updated output data being generated by the artificial intelligence model based on the input data, the output data, and the corrective input data.

20. The one or more tangible processor-readable storage media of claim 15, the input data comprising a transcript of a conversation, the output data comprising a summary of the transcript.
